(19) United States
(12) Patent Application Publication
(10) Pub. No.: US 2014/0150338 A1
(43) Pub. Date: Jun. 5, 2014

(54) FILM FOR PLANT CULTIVATION

(71) Applicants: Masahiro Takafuji, Kurashiki-shi (JP); Takanori Isozaki, Kurashiki-shi (JP)

(72) Inventors: Masahiro Takafuji, Kurashiki-shi (JP); Takanori Isozaki, Kurashiki-shi (JP)

(21) Appl. No.: 13/820,906

(22) PCT Filed: Sep. 9, 2011
(86) PCT No.: PCT/JP2011/070596

§ 371 Date: Mar. 27, 2013

(30) Foreign Application Priority Data
Sep. 28, 2010 (JP) 2010-217287

(51) Int. Cl. A01G 1/00; B29D 7/01

(52) U.S. Cl. CPC A01G 1/001; B29D 7/01
USPC 47/58.1 R; 264/234; 526/317.1

(57) ABSTRACT

[Task] The objects of the present invention are to provide: a polyvinyl alcohol (PVA) film for plant cultivation which is capable of suppressing root penetration while exhibiting excellent nutrient permeability; a method for producing the same; and a method for plant cultivation using the same.

[Means to Achieve the Task] The present invention is directed to a PVA film for plant cultivation, wherein a thicknesswise-directional average value of birefringence in a machine direction of the film is from 4.0×10⁻³ to 12.0×10⁻³ and a swelling degree of the film is from 150 to 180%; a method for producing a PVA film for plant cultivation, which comprises a step in which a PVA film having a moisture content of from 5 to 20% by mass is stretched in the ratio of from 1.3 to 1.7 times and a step in which the stretched film is heat-treated at a temperature in the range of from 130 to 170° C.; and a method for plant cultivation, which comprises cultivating the plant in the manner in which the plant and the PVA film for plant cultivation described above are directly contacted.

### TECHNICAL FIELD

The present invention relates to a polyvinyl alcohol film used as a film for plant cultivation, a method for producing the same, and a method for plant cultivation using the same.

### TECHNICAL BACKGROUND

In the nutriculture of plants, there has been proposed a method for plant cultivation which suppresses the putrefaction of a nutrient fluid by providing a film between the nutrient fluid and the plant body (see Patent Document 1). It is important that the said film allows the permeation of nutrients therethrough. Film materials suggested in the patent document are hydrophilic materials, such as polyvinyl alcohol, cellophane, cellulose acetate, cellulose nitrate, ethyl cellulose and polyester. However, when such a hydrophilic material is simply used for plant cultivation by the above-mentioned method, there is still a concern about the putrefaction of the nutrient fluid caused by bacteria and the like which may move into the nutrient fluid through the parts penetrated by the roots. Accordingly, there is a demand for a film for plant cultivation which allows nutrients to easily permeate therethrough, but prevents the roots from penetrating therethrough.

### PRIOR ART DOCUMENTS

### Patent Documents

Patent Document 1: Unexamined Japanese Patent Application Laid-Open Specification No. 2008-61503
Patent Document 2: Unexamined Japanese Patent Application Laid-Open Specification No. Hei 10-325905

### SUMMARY OF THE INVENTION

### Problem to Be Solved by the Invention

The improvement in nutrient permeability of a film and the suppression of root penetration through the film have been considered as contradictory properties, and up to now, a film for plant cultivation fulfilling both properties simultaneously has not been known. For example, in order to suppress root penetration, it is considered to increase the strength of a polyvinyl alcohol film; however, when heat treatment or stretch orientation treatment which have conventionally been known as methods for increasing the strength of a polyvinyl alcohol film are simply performed, there is a problem of deterioration in nutrient permeability. On the other hand, an excellent nutrient permeability is exhibited by using, as a film for plant cultivation, a polyvinyl alcohol film having been subjected to a mild heat treatment or a polyvinyl alcohol film having been stretched after a satisfactory drying or heat treatment (such as a film described in Patent Document 2); however, there is a problem in that roots penetrate the film easily.

In this situation, the objects of the present invention are to provide: a polyvinyl alcohol film for plant cultivation which is capable of suppressing root penetration while exhibiting excellent nutrient permeability; a method for producing the same; and a method for plant cultivation using the same.

### Means to Solve the Problem

The present inventors have made intensive studies to achieve the above-mentioned objects. As a result, it has been found that a polyvinyl alcohol film capable of suppressing root penetration while exhibiting excellent nutrient permeability can be obtained by controlling the birefringence and swelling degree of the polyvinyl alcohol film to fall within respective specific ranges. The present invention has been completed by performing further studies, based on these findings.

Accordingly, the present invention relates to the following.

[1] A polyvinyl alcohol film for plant cultivation, wherein a thicknesswise-directional average value of birefringence in a machine direction of the film is from 4.0×10⁻³ to 12.0×10⁻³ and a swelling degree of the film is from 150 to 180% (Hereinafter, “polyvinyl alcohol” may be abbreviated to “PVA”.);
[2] The PVA film for plant cultivation according to item [1] above, wherein a penetration resistance of the film is 15.0 N or more in terms of a maximum load measured by a method comprising immersing the film in water at 20° C. for 1 minute and then piercing the film with a thick iron wire nail (CN65) defined in JIS A5508:2009, provided that the maximum load is a converted value exhibiting a maximum load when the thickness of the film is 60 μm.
[3] A method for producing a PVA film for plant cultivation, which comprises a step in which a PVA film having a moisture content of from 5 to 20% by mass is stretched in the ratio of from 1.3 to 1.7 times and a step in which the stretched film is heat-treated at a temperature in the range of from 130 to 170° C.;
[4] The method according to item [3] above, which further comprises, after the said step of stretching and before the said step of heat treatment, a step in which the film is dried so that the moisture content of the film becomes from 1 to 15% by mass;
[5] A method for plant cultivation, which comprises cultivating the plant in the manner in which the plant and the PVA film for plant cultivation according to item [1] or [2] above are directly contacted.

### Effects of the Invention

According to the present invention, there are provided a PVA film for plant cultivation which is capable of suppressing root penetration while exhibiting excellent nutrient permeability, a method for producing the same, and a method for plant cultivation using the same.

### MODE FOR CARRYING OUT THE INVENTION

Hereinbelow, the present invention will be explained in detail.

In the PVA film for plant cultivation of the present invention, it is needed that a thicknesswise-directional average value of birefringence in a machine direction of the film is in the range of from 4.0×10⁻³ to 12.0×10⁻³, preferably in the range of from 4.5×10⁻³ to 11.5×10⁻³, and more preferably in the range of from 5.0×10⁻³ to 11.0×10⁻³. When the thicknesswise-directional average value of birefringence in a machine direction is less than 4.0×10⁻³, the PVA film for plant cultivation becomes unsuitable because roots easily penetrate therethrough. On the other hand, when the thicknesswise-directional average value of birefringence in a machine direction is more than 12.0×10⁻³, the film becomes unsuitable because the nutrient permeability is deteriorated. The thicknesswise-directional average value of birefringence in a machine direction can be measured in accordance with the method described below at the section “EXAMPLES”.

In the PVA film for plant cultivation of the present invention, it is needed that a swelling degree of the film is in the range of from 150 to 180%, preferably in the range of from 153 to 178%, and more preferably in the range of from 155 to 175%. When the swelling degree is more than 180%, the PVA film for plant cultivation becomes unsuitable because roots easily penetrate therethrough. On the other hand, when the swelling degree is less than 150%, the film becomes unsuitable because the nutrient permeability is deteriorated. In the present specification, the swelling degree of the PVA film for plant cultivation is a percentage value obtained by dividing the mass of the PVA film for plant cultivation immersed in distilled water at 30° C. for 30 minutes by the mass of the immersed PVA film for plant cultivation after drying at 105° C. for 16 hours. Specifically, the swelling degree can be measured in accordance with the method described below at the section “EXAMPLES”. The swelling degree can be adjusted by changing the conditions for the heat treatment and, in general, the swelling degree can be lowered by increasing both the temperature and time for the heat treatment.

As a PVA constituting the PVA film for plant cultivation of the present invention, there can be used a PVA obtainable by saponification of a polyvinyl ester which is obtainable by polymerizing one kind or two or more kinds of vinyl esters, such as vinyl acetate, vinyl formate, vinyl propionate, vinyl butyrate, vinyl pivalate, vinyl versatate, vinyl laurate, vinyl stearate, vinyl benzoate and isopropenyl acetate. Among the above-mentioned vinyl esters, vinyl acetate is preferred from the viewpoint of easy production of PVA, availability, cost and the like.

The polyvinyl ester is preferably one obtained by polymerizing only one kind or two or more kinds of vinyl esters as monomers, and more preferably one obtained by polymerizing only one kind of vinyl ester as a monomer. However, the polyvinyl ester may be a copolymer of one kind or two or more kinds of vinyl esters with other monomer copolymerizable therewith, as long as the effects of the present invention are not adversely affected.

Examples of other monomers copolymerizable with vinyl ester mentioned above include C₂-C₃₀ α-olefins, such as ethylene, propylene, 1-butene and isobutene; (meth)acrylic acid and salts thereof; esters of (meth)acrylic acid, such as methyl(meth)acrylate, ethyl(meth)acrylate, n-propyl(meth)acrylate, i-propyl(meth)acrylate, n-butyl(meth)acrylate, i-butyl(meth)acrylate, t-butyl(meth)acrylate, 2-ethylhexyl(meth)acrylate, dodecyl(meth)acrylate and octadecyl(meth)acrylate; (meth)acrylamide derivatives, such as (meth)acrylamide, N-methyl(meth)acrylamide, N-ethyl(meth)acrylamide, N,N-dimethyl(meth)acrylamide, diacetone(meth)acrylamide, (meth)acrylamidopropanesulfonic acid and salts thereof, (meth)acrylamidopropyldimethylamine and salts thereof, N-methylol(meth)acrylamide and derivatives thereof; N-vinyl amides, such as N-vinyl formamide, N-vinyl acetamide and N-vinylpyrrolidone; vinyl ethers, such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether and stearyl vinyl ether; vinyl cyanides, such as (meth)acrylonitrile; vinyl halides, such as vinyl chloride, vinylidene chloride, vinyl fluoride and vinylidene fluoride; allyl compounds, such as allyl acetate and allyl chloride; maleic acid and its salts, esters and anhydrides; itaconic acid and its salts, esters and anhydrides; vinylsilyl compounds, such as vinyltrimethoxysilane; and unsaturated sulfonic acids. The above-mentioned polyvinyl ester may have structural units derived from one kind or two or more kinds of other monomers described above.

The proportion of the structural unit derived from other monomer described above in the polyvinyl ester mentioned above is preferably 15 mol % or less, more preferably 10 mol % or less, and still more preferably 5 mol % or less, based on the total number of moles of the structural units constituting the polyvinyl ester.

Especially when other monomer described above is a monomer (such as (meth)acrylic acid or unsaturated sulfonic acid) which may promote the water solubility of the resultant PVA, the proportion of the structural unit derived from other monomer in the polyvinyl ester is preferably 5 mol % or less, and more preferably 3 mol % or less, based on the total number of moles of the structural units constituting the polyvinyl ester, in order to prevent dissolution of the resultant PVA film during the use of it as a film for plant cultivation and the like.

The PVA may be modified with one kind or two or more kinds of monomer capable of graft copolymerization, as long as the effects of the present invention are not adversely affected. Examples of the said monomers capable of graft copolymerization include unsaturated carboxylic acids and derivatives thereof; unsaturated sulfonic acids and derivatives thereof; and C₂-C₃₀ α-olefins. The proportion of the structural units derived from the monomer capable of graft copolymerization in the PVA is preferably 5 mol % or less, based on the total number of moles of the structural units constituting the PVA.

A part of the hydroxyl groups of the PVA may or may not be crosslinked. Further, a part of the hydroxyl groups of the PVA may be reacted with an aldehyde compound, such as acetaldehyde or butyraldehyde, to thereby form an acetal structure. Alternatively, the groups may not be reacted with the aldehyde compound and not form an acetal structure.

The polymerization degree of the PVA is preferably in the range of from 1,500 to 6,000, more preferably in the range of from 1,800 to 5,000, and still more preferably in the range of from 2,000 to 4,000. When the polymerization degree is less than 1,500, roots tend to easily penetrate through the film. On the other hand, when the polymerization degree is more than 6,000, it tends to result in increase of the production costs, a defective processability for film formation, and the like. The polymerization degree used in the present specification is an average polymerization degree measured in accordance with the description of JIS K6726-1994.

From the viewpoint of water resistance of the resultant PVA film for plant cultivation, the saponification degree of the PVA is preferably at least 98.0 mol %, more preferably at least 98.5 mol %, and still more preferably at least 99.0 mol %. When the saponification degree is less than 98.0 mol %, roots tends to easily penetrate through the film. In the present specification, the saponification degree of the PVA is the proportion (mol %) of the number of moles of vinyl alcohol units to the total number of moles of the structural units (typically vinyl ester units) capable of being converted into vinyl alcohol units by saponification and the moles of the vinyl alcohol units. The saponification degree can be measured in accordance with the description of JIS K6726-1994.

For effectively suppressing the penetration of the roots through the film, it is preferred that the PVA film for the plant cultivation of the present invention does not comprise any plasticizer. However, the film may comprise a plasticizer for the purposes such as improving the productivity and handling properties of the PVA film, as long as the effects of the present invention are not adversely affected. A polyhydric alcohol is preferably used as the plasticizer. Specific examples of the polyhydric alcohols include ethylene glycol, glycerol, propylene glycol, diethylene glycol, diglycerol, triethylene glycol, tetraethylene glycol and trimethylol propane. The PVA film for plant cultivation of the present invention may comprise one kind or two or more kinds of the above-mentioned plasticizers. Among the above-mentioned plasticizers, glycerol is preferred from the viewpoint of the improvement in the handling properties of the PVA film.

The plasticizer content of the PVA film for plant cultivation of the present invention is preferably in the range of from 0 to 20 parts by mass, more preferably in the range of from 0 to 12 parts by mass, and still more preferably in the range of from 0 to 8 parts by mass, relative to 100 parts by mass of the PVA comprised in the PVA film.

When the PVA film for plant cultivation is produced using a raw material liquid explained below, it is preferred to add a surfactant to the raw material liquid. By adding the surfactant, it becomes possible to improve the film formability, thereby suppressing the occurrence of unevenness in thickness of the resultant PVA film for plant cultivation. Further, it becomes possible to enable an easy release of the PVA film from a metal roll or belt when they are used during the film formation in the production of the PVA film. When a PVA film for plant cultivation is produced from a raw material liquid comprising a surfactant, the film will comprise the surfactant. There is no particular limitation on the kind of the surfactant mentioned above. However, from the viewpoint of releasability of the film from the metal roll or belt, it is preferred that the surfactant is an anionic surfactant or a nonionic surfactant, and more preferably a nonionic surfactant.

Examples of anionic surfactants include carboxylic acid type surfactants, such as potassium laurate; sulfuric acid ester type surfactants, such as polyoxyethylene lauryl ether sulfate and octyl sulfate; and sulfonic acid type surfactants, such as dodecylbenzenesulfonate.

Examples of nonionic surfactants include alkyl ether type surfactants, such as polyoxyethylene oleyl ether; alkylphenyl ether type surfactants, such as polyoxyethylene octylphenyl ether; alkyl ester type surfactants, such as polyoxyethylene laurate; alkylamine type surfactants, such as polyoxyethylene laurylamino ether; alkylamide type surfactants, such as polyoxyethylene lauric acid amide; polypropylene glycol ether type surfactants, such as polyoxyethylene polyoxypropylene ether; alkanolamide type surfactants, such as oleic acid diethanolamide; and allylphenyl ether type surfactants, such as polyoxyalkylene allylphenyl ether.

One kind of the surfactant may be used singly. Alternatively, two or more kinds of the surfactants may be used in combination.

When a surfactant is added to the raw material liquid, the content of the surfactant is preferably in the range of from 0.01 to 0.5 part by mass, more preferably in the range of from 0.02 to 0.3 part by mass, and still more preferably in the range of from 0.05 to 0.1 part by mass, relative to 100 parts by mass of the PVA. The surfactant content of 0.01 part by mass or more, relative to 100 parts by mass of the PVA, is advantageous for improving the film formability and releasability. On the other hand, the surfactant content of 0.5 part by mass or less, relative to 100 parts by mass of the PVA, is advantageous for suppressing the bleeding out of the surfactant on the surface of the resultant PVA film for plant cultivation and thereby suppressing the occurrence of blocking.

If desired, the PVA film for plant cultivation of the present invention may further comprise components, such as an antioxidant, an antifreezing agent, a pH adjusting agent, a masking agent, an antidiscoloration agent and a lubricant.

In the PVA film for plant cultivation of the present invention, the proportion of the total content of the PVA, the plasticizer and the surfactant is preferably in the range of from 50 to 100% by mass, more preferably in the range of from 80 to 100% by mass, and still more preferably in the range of from 95 to 100% by mass.

The present invention also encompasses a method for producing a PVA film for plant cultivation, which comprises a step (stretching step) in which a PVA film having a moisture content of from 5 to 20% by mass is stretched in the ratio of from 1.3 to 1.7 times and a step (heat treatment step) in which the stretched film is heat-treated at a temperature in the range of from 130 to 170° C. By the said method, it becomes possible to efficiently and easily produce the PVA film for plant cultivation of the present invention.

The moisture content of the PVA film to be subjected to the stretching step is in the range of from 5 to 20% by mass, preferably in the range of from 7 to 18% by mass, and more preferably in the range of from 10 to 15% by mass. When the moisture content is less than 5% by mass, roots easily penetrate through the resultant PVA film for plant cultivation. Also, when the moisture content is more than 20% by mass, roots easily penetrate through the resultant PVA film for plant cultivation. The moisture content of a PVA film can be calculated from the mass of the PVA film before and after drying. Specifically, from the mass (A) of the subject PVA film and the mass (B) of the PVA film after drying under vacuum at 50° C. for 4 hours, the moisture content can be calculated in accordance with the following formula (1):

Moisture content (% by mass)=100×[(A−B)/A] (1).

The stretching ratio in the stretching step is in the range of from 1.3 to 1.7 times, preferably in the range of from 1.35 to 1.65 times, and more preferably in the range of from 1.4 to 1.6 times. When the stretching ratio is less than 1.3 times, roots easily penetrate through the resultant PVA film for plant cultivation. On the other hand, when the stretching ratio is more than 1.7 times, the nutrient permeability is likely to be deteriorated. In the present specification, the stretching ratio is a value obtained by dividing the length in the stretching direction of the film after stretching by the length in the stretching direction of the film before stretching. In other words, when the stretching ratio is 1, the film is not stretched. For example, when a film in a continuous length is subjected to continuous monoaxial stretching in a machine direction (i.e., lengthwise direction of the film in a continuous length) by using a plurality of rolls, the stretching ratio can be easily adjusted by changing the ratio between the peripheral velocities of each roll. In general, a value obtained by dividing the peripheral velocity of a downstream roll by the peripheral velocity of an upstream roll corresponds to the above-mentioned stretching ratio.

A PVA film to be subjected to the stretching step can be produced by using, for example, a raw material liquid obtained by dissolving the above-mentioned PVA and, if desired, further components (such as a plasticizer and a surfactant) in a solvent; or a raw material liquid comprising a PVA, a solvent and, if desired, further components (such as a plasticizer and a surfactant) wherein the PVA is in a molten state.

Examples of solvents used for preparing the raw material liquid include water, dimethylsulfoxide, dimethylformamide, dimethylacetamide, N-methylpyrrolidone, ethylene glycol, glycerol, propylene glycol, diethylene glycol, triethylene glycol, tetraethylene glycol, trimethylol propane, ethylene diamine and diethylene triamine. One kind or two or more kinds of these solvents can be used. Among the above-mentioned solvents, water is preferred from the viewpoint of low impact on environment and high recoverability.

The volatile component factor of the raw material liquid (i.e., the proportion of volatile components, such as a solvent, which are removed by volatilization or evaporation during the film formation, in the raw material liquid) may vary depending on the method and conditions employed in the film formation. However, it is preferred that the volatile component factor is in the range of from 50 to 95% by mass, and more preferably in the range of from 55 to 90% by mass. The volatile component factor of at least 50% by mass is advantageous for preventing the viscosity of the raw material liquid from becoming too high, thereby enabling smooth filtration and degassing during the preparation of the raw material liquid. As a result, it becomes possible to easily produce a PVA film in which the impurities and defects are suppressed to low levels. On the other hand, the volatile component factor of 95% by mass or less is advantageous for preventing the concentration in the raw material liquid from becoming too low, thereby enabling easy industrial production of the PVA film.

Examples of methods for forming a PVA film from the raw material liquid include a wet film forming method, a gel film forming method, a cast film forming method by dry process, and an extrusion film forming method. Only one method of these methods can be employed. Alternatively, two or more methods of these methods can be employed in combination.

Among the film forming methods, preferred is the cast film forming method using a T-shaped slit die, a hopper plate, an I-die, a lip coater or the like. As a specific example of a cast film forming method, there can be mentioned a method comprising discharging or casting the raw material liquid uniformly on the peripheral surface of a rotating heated roll (or belt) positioned at the uppermost stream; drying the film discharged or cast on the peripheral surface of the roll (or belt) by evaporating the volatile component from one side of the film; further drying the film either on the peripheral surfaces of one or more rotating heated rolls positioned in the downstream or by passing the film through a hot-air drying device; and rolling up the dried film with a roll-up device. This method can be preferably employed in industrial formation of the film. The drying by the heated roll and the drying by the hot-air drying device can be performed in combination.

The PVA film obtained by adjusting the moisture content of the PVA film produced by the above-mentioned method can be used as a PVA film to be subjected to the stretching step. The moisture content of the PVA film can be adjusted by using a moisture adjustment device, by spraying or coating water on the film, or by immersing the film in water for a predetermined time. However, from the viewpoint of high productivity, it is preferred that the production method of the present invention is performed by subjecting a PVA film to the stretching step when the moisture content of the PVA film is within the above-mentioned range during the above-mentioned series of steps, namely during the following series of steps: discharging or casting the raw material liquid uniformly on the peripheral surface of a rotating heated roll (or belt) positioned at the uppermost stream; drying the film discharged or cast on the peripheral surface of the roll (or belt) by evaporating the volatile component from one side of the film; and further drying the film either on the peripheral surfaces of one or more rotating heated rolls positioned in the downstream or by passing the film through a hot-air drying device.

The stretched PVA film obtained after the stretching step is preferably dried so that the moisture content of the film becomes from 1 to 15% by mass before the heat treatment step. When the method comprises the step (drying step) in which the film is dried before the heat treatment step, the effects of the subsequent heat treatment step can be improved. The moisture content of the film after the drying step is more preferably in the range of from 2 to 13% by mass, and more preferably in the range of from 3 to 10% by mass. The drying temperature employed in the drying step is preferably in the range of from 30 to 100° C., and more preferably in the range of from 40 to 95° C.

The swelling degree of the resultant PVA film for plant cultivation can be adjusted by the heat treatment step. Examples of heat treatment methods include a method in which a film is contacted with a heat roll and a method in which hot air is blown to the film. The method in which a film is contacted with a heat roll is preferred from the viewpoint of uniformly heating the film. Only one method of these heat treatment methods can be employed. Alternatively, two or more methods of these heat treatment methods can be employed in combination.

From the viewpoint of effectively adjusting the swelling degree of the resultant PVA film for plant cultivation, the temperature for the heat treatment step is in the range of from 130 to 170° C., preferably in the range of from 133 to 168° C., and more preferably in the range of from 135 to 165° C. When the temperature is below 130° C., roots easily penetrate through the resultant PVA film for plant cultivation. On the other hand, when the temperature exceeds 170° C., the nutrient permeability is deteriorated.

The heat treatment time for the heat treatment step is preferably at least 3 seconds, more preferably at least 4 seconds, and still more preferably at least 5 seconds. The heat treatment for at least 3 seconds is advantageous for uniformly adjusting the swelling degree. With respect to the upper limit of the heat treatment time, there is no particular limitation; however, from the viewpoint of, for example, productivity, it is preferred that the heat treatment time is not more than 10 minutes.

The PVA film for plant cultivation of the present invention is capable of suppressing root penetration. As explained in detail in the section “EXAMPLES” described below, the suppressive effect against root penetration can be evaluated, as a model evaluation, by a penetration resistance of the film in terms of a maximum load measured by a method comprising immersing the film in water at 20° C. for 1 minute and then piercing the film with a thick iron wire nail (CN65) defined in JIS A5508:2009. In other words, the higher the penetration resistance, the higher the suppressive effect against root penetration. Since the penetration resistance tends to increase in accordance with a decrease in the swelling degree, an increase in the thickness of the film and an increase in the thicknesswise-directional average value of birefringence in a machine direction, it is preferred that these properties are appropriately adjusted depending on the desired penetration resistance. In the PVA film for plant cultivation of the present invention, the penetration resistance (60 μm-value) when the thickness of the film is 60 μm is preferably 15.0 N or more, more preferably 15.2 N or more, and still more preferably 15.5 N or more. The penetration resistance (60 μm-value) in the above-mentioned range is advantageous for more effectively suppressing the penetration of the roots through the PVA film for plant cultivation of the present invention. When the thickness of the PVA film for plant cultivation of the present invention is not 60 μm, the penetration resistance (60 μm-value) can be obtained by converting a penetration resistance (X μm-value) measured using the said PVA film for plant cultivation having the thickness of X μm to a value exhibiting a penetration resistance when the thickness of the film is 60 μm by the following formula (2):

Penetration resistance (60 μm-value)=Penetration resistance (X μm-value)×60/X (2).

From the viewpoint of penetration resistance, productivity and handling properties, the thickness of the PVA film for plant cultivation of the present invention is preferably in the range of from 10 to 200 μm, more preferably in the range of from 20 to 150 μm, still more preferably in the range of from 30 to 120 μm, and most preferably in the range of from 40 to 100 μm. The thickness of the PVA film for plant cultivation can be determined as the average of the thicknesses which are measured at arbitrarily selected 5 points of the film.

With respect to the shape of the PVA film for plant cultivation of the present invention, there is no particular limitation, and the PVA film may have the shape of a quadrilateral (i.e., square, rectangle or the like), a circle, a triangle or the like. The shape of the PVA film for plant cultivation of the present invention can be chosen depending on the using form thereof. However, the shape in which a film in a continuous length is rolled-up in roll is preferred because such a film can be produced continuously and the storage and transport of the film are easy. With respect to the width (i.e., the length in a direction perpendicular to the machine direction on the surface of the film) of the above-mentioned PVA film for plant cultivation in a continuous length, there is no particular limitation. In a case, for example, where a film is used for plant cultivation with the width at the film formation, too large a width tends to make it cumbersome to tend plants. Accordingly, the width of the film is preferably 2 m or less, and more preferably in the range of from 10 cm to 1.5 m. Since a wide film in a continuous length can be used after cutting into a film with a desired width, a wide film (with, for example, a width of from 2 to 4 m) is also preferred from the viewpoint of productivity. Further, with respect to the length (i.e., the length in the machine direction) of the PVA film for plant cultivation in a continuous length, there is no particular limitation, and for example, the length of the film may be in the range of from 5 to 5,000 m.

The PVA film for plant cultivation of the present invention is capable of suppressing root penetration while exhibiting excellent nutrient permeability, which enables excellent plant growth. The PVA film for plant cultivation of the present invention can be used as it is, or after forming in any desired form obtained by, for example, cutting and lamination.

As a method of using the PVA film for plant cultivation of the present invention, there can be mentioned a method comprising cultivating the plant in the manner in which the plant and the PVA film for plant cultivation of the present invention are directly contacted, examples of which include a method wherein the plant is cultivated on the PVA film for plant cultivation of the present invention. Specific examples of methods of using the PVA film for plant cultivation of the present invention include a method comprising placing the PVA film for plant cultivation of the present invention having a desired form on the ground soil in which, if necessary, a pit is formed, placing a plant body on the film to thereby separate the plant body from the ground soil, and growing the plant while preventing direct contact between the ground soil and the plant; and a method comprising placing the PVA film for plant cultivation of the present invention having a desired form on an aqueous solution (nutrient fluid) containing plant nutrients, placing a plant body on the film to thereby separate the plant body from the aqueous solution, and growing the plant while preventing direct contact between the aqueous solution and the plant. By the above-mentioned methods, it becomes possible to suppress the contamination of plants by microorganisms, bacteria, viruses and residual agrochemicals in the ground soil, or to suppress the putrefaction of the aqueous solution containing plant nutrients by bacteria and the like entering the aqueous solution where the roots of the plants mediate the entry of the bacteria and the like.

### EXAMPLES

The present invention will be described in more detailed by making reference to the following Examples and Comparative Examples, but they should not be construed as limiting the scope of the present invention.

The methods for measuring or evaluating the thicknesswise-directional average value of birefringence in a machine direction, swelling degree, penetration resistance and nutrient permeability of a PVA film, and root penetration test are described below.

### Method for Measuring the Thicknesswise-Directional Average Value of Birefringence in a Machine Direction of a PVA Film

(i) A small piece having a size of 2 mm (MD)×10 mm (TD) was cut out from a central part in the widthwise direction (TD) of an arbitrarily selected location in the machine direction (MD) of the PVA film obtained in Examples or Comparative Examples mentioned below. The thus obtained small piece was sandwiched between 100 μm-thick PET films, and the resultant was further sandwiched between wooden frames, followed by attachment to a microtome.

(ii) The small piece was sliced by the microtome at intervals of about 10 μm in a direction parallel to the machine direction (MD) of the piece, thereby obtaining sliced pieces (MD×TD=2 mm×about 10 μm) for observation. One of the sliced pieces was placed on a slide glass with the cross section (one face of the faces having a size of 2 mm×thickness of the film) of the piece facing upward. The accurate thickness of the cross section of the sliced piece having a thickness, of about 10 μm was measured from the side of the cross section of the piece by means of a microscope (manufactured by Keyence Corporation).

(iii) Subsequently, the sliced piece on the slide glass having its cross section facing upward was sealed with a cover glass and a silicone oil (refractive index: 1.04).

(iv) The retardation over the whole cross section of the sliced piece was measured by means of a 2D photoelasticity analyzing system “PA-micro” (manufactured by Photonic Lattice, Inc.), and the retardation data for the whole thicknesswise direction of the PVA film (i.e., retardation data for each thickness level of the film) were obtained from the measured retardation over the whole cross section of the sliced piece.

(v) Each of the above-obtained retardation data for the whole thicknesswise direction of the PVA film was divided by the thickness of the cross section of the sliced piece measured using the microscope in step (ii) to thereby obtain birefringence values for the whole thicknesswise direction of the PVA film. These values were averaged in a thicknesswise direction to thereby obtain the thicknesswise-directional average value of birefringence in a machine direction.

### Method for Measuring the Swelling Degree of a PVA Film

A PVA film having a weight of 1.5 g was cut out from the PVA film obtained in Examples or Comparative Examples mentioned below. The cut-out PVA film was immersed in 1,000 g of distilled water at 30° C. for 30 minutes. The immersed PVA film was taken out from the distilled water, and after removing moisture on the surface of the film by using a filter paper, the mass “X” of the immersed PVA film was measured. Subsequently, the PVA film was dried in a dryer set at 105° C. for 16 hours, followed by measuring the mass “Y” of the dried PVA film. The swelling degree was calculated in accordance with the following formula (3):

Swelling degree (%)=100×X/Y (3).

### Method for Measuring the Penetration Resistance of a PVA Film

A PVA film having a size of 3 cm×3 cm was cut out from the PVA film obtained in Examples or Comparative Examples mentioned below. The cut-out PVA film was immersed in 1,000 g of distilled water at 20° C. for 1 minute. The immersed PVA film was taken out from the distilled water and sandwiched between two stainless plates each having a size of 3 cm×3 cm and a thickness of 1 mm, and having a hole (diameter: 1 cm) at the center thereof. The PVA film and the stainless plates were secured at two opposite parts (right and left sides) by clips, thereby obtaining a sample for measurement. The obtained sample was securely attached to a gripper at the bottom portion of a desktop precision universal testing machine “Autograph AGS-J” (manufactured by Shimadzu Corporation), and a thick iron wire nail CN65 defined in JIS A5508:2009 was securely attached to a gripper at the top portion of the machine. The PVA film located at the center of the holes of the stainless plates was pierced with the nail at a rate of 100 mm/minute. The obtained maximum load was defined as the penetration resistance (unit: N). For preventing the drying of the PVA film, the operations from taking out the film from water after immersing to piercing the film with the nail were done so that the total time for these operations did not exceed 30 seconds. Further, the measurement temperature was set at 20° C. The penetration resistance of the PVA film was evaluated in accordance with the following criteria:

“∘” (excellent): the penetration resistance (60 μm-value) being 15.0 N or more; and

“x” (poor): the penetration resistance (60 μm-value) being less than 15.0 N.

### Method for Evaluating the Nutrient Permeability of a PVA Film

A sieve was placed in a bowl, and the PVA film obtained in Examples or Comparative Examples mentioned below was placed on the sieve. 150 g of 5% aqueous glucose solution was placed between the bowl and the PVA film, and 150 g of distilled water was placed on the PVA film so that the aqueous glucose solution and distilled water were separated by the PVA film. The whole of the resultant system was wrapped with a polyvinylidene chloride film to prevent the evaporation of water from the system. The resultant system was allowed to stand still at 23° C. for 24 hours, and the glucose concentration of each of the bowl-side liquid (initially aqueous glucose solution) and sieve-side liquid (initially distilled water) was measured. The nutrient permeability of the film was evaluated in accordance with the following criteria:

“∘” (excellent): the concentration difference between these liquids being less than 2.0%; and

“x” (poor): the concentration difference between these liquids being 2.0% or more.

The glucose concentration used in this evaluation was a Brix concentration measured by means of a digital refractometer “AR200” (manufactured by Thermo Fisher Scientific K.K.).

### Root Penetration Test

200 g of a nutrient fluid (200 times diluted “Hyponex” (manufactured by Hyponex Japan K.K.) with EC=2) was placed in a bowl, and the PVA film obtained in Examples or Comparative Examples mentioned below was placed on the nutrient fluid so that one surface of the film was in contact with the nutrient fluid. 50 g of coconut shell chips was placed on the PVA film as a soil, and lawn grass seeds (Western lawn called “bentgrass highland”, manufactured by Takii & Co, Ltd.) were seeded thereto. The seeds were sufficiently watered by spraying water with a sprayer, and the whole of the resultant system was wrapped with a polyvinylidene chloride film to prevent the evaporation of water from the system. The system was kept indoor at 15 to 25° C. and cultivated using an artificial light. The polyvinylidene chloride film was removed when the lawn grass grew to be in contact with the polyvinylidene chloride film. The root penetration was evaluated in accordance with the following criteria:

“∘” (excellent): the root penetration through the PVA film being observed on or after day 150 from the start of the cultivation; and

“x” (poor): the root penetration through the PVA film being observed before day 150 from the start of the cultivation.

### Example 1

A raw material liquid for film formation comprising 100 parts by mass of a PVA (polymerization degree: 2,400; saponification degree: 99.9 mol %) obtained by saponification of homopolymer of vinyl acetate, 0.1 part by mass of sodium polyoxyethylene lauryl ether sulfate as a surfactant, and water, and having a volatile component factor of 66% by mass was discharged through a T-die onto a primary drying roll and dried on the primary drying roll until the moisture content thereof becoming 22% by mass. The resultant PVA film was released from the primary drying roll and dried further using a plurality of drying rolls positioned in the downstream of the primary drying roll. In the above-mentioned drying, when the moisture content of the PVA film was 15% by mass, the ratio of the peripheral velocities between the drying rolls were changed to thereby stretch the PVA film monoaxially in a machine direction at a stretching ratio of 1.4 times. On the other hand, the other ratios (i.e., [the peripheral velocity of a downstream drying roll]/[the peripheral velocity of an upstream drying roll]) of the peripheral velocities between the drying rolls were set to be 1.0. Subsequently, the PVA film was dried by means of the drying rolls until the moisture content thereof becoming 3% by mass. The resultant film was further heat-treated for 20 seconds by a heat treatment roll having a surface temperature of 160° C., and then, the film was rolled up, thereby obtaining a PVA film in a continuous length having a thickness of 60 μm.

The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Example 2

A PVA film in a continuous length having a thickness of 60 μm was obtained in substantially the same manner as in Example 1, except that the stretching ratio was changed from 1.4 times to 1.6 times. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Example 3

A PVA film in a continuous length having a thickness of 60 μm was obtained in substantially the same manner as in Example 1, except that the surface temperature of the heat treatment roll was changed from 160° C. to 140° C. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Example 4

A PVA film in a continuous length having a thickness of 60 μm was obtained in substantially the same manner as in Example 1, except that the monoaxial stretching was performed when the moisture content of the PVA film was 10% by mass instead of 15% by mass. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 1

A PVA film in a continuous length having a thickness of 60 μm was obtained in substantially the same manner as, in Example 1, except that the monoaxial stretching was not performed. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 2

A PVA film in a continuous length having a thickness of 60 μm was obtained in substantially the same manner as in Comparative Example 1, except that the surface temperature of the heat treatment roll was changed from 160° C. to 140° C. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 3

A PVA film in a continuous length having a thickness of 60 μm was obtained in substantially the same manner as in Comparative Example 1, except that the surface temperature of the heat treatment roll was changed from 160° C. to 180° C. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 4

A PVA film in a continuous length having a thickness of 60 μm was obtained in substantially the same manner as in Example 1, except that the stretching ratio was changed from 1.4 times to 1.2 times. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 5

A PVA film in a continuous length having a thickness of 60 μm was obtained in substantially the same manner as in Example 1, except that the stretching ratio was changed from 1.4 times to 1.8 times. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 6

A PVA film in a continuous length having a thickness of 60 μm was obtained in substantially the same manner as in Example 1, except that the surface temperature of the heat treatment roll was changed from 160° C. to 180° C. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 7

A PVA film in a continuous length having a thickness of 60 μm was obtained in substantially the same manner as in Example 1, except that the surface temperature of the heat treatment roll was changed from 160° C. to 120° C. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 8

A PVA film in a continuous length having a thickness of 60 μm was obtained in substantially the same manner as in Example 1, except that the monoaxial stretching was performed when the moisture content of the PVA film was 22% by mass instead of 15% by mass. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 9

A PVA film in a continuous length having a thickness of 60 μm was obtained in substantially the same manner as in Example 1, except that the monoaxial stretching was performed when the moisture content of the PVA film was 3% by mass instead of 15% by mass. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 10

A PVA film in a continuous length having a thickness of 60 μm was obtained in substantially the same manner as in Example 2, except that the monoaxial stretching was performed when the moisture content of the PVA film was 3% by mass instead of 15% by mass. The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 11

A raw material liquid for film formation comprising 100 parts by mass of a PVA (polymerization degree: 2,400; saponification degree: 99.9 mol %) obtained by saponification of homopolymer of vinyl acetate, 0.1 part by mass of sodium polyoxyethylene lauryl ether sulfate as a surfactant, and water, and having a volatile component factor of 66% by mass was discharged through a T-die onto a primary drying roll and dried on the primary drying roll until the moisture content thereof becoming 22% by mass. The resultant PVA film was released from the primary drying roll and dried further by using a plurality of drying rolls positioned in the downstream of the primary drying roll, thereby obtaining a PVA film having a moisture content of 1% by mass. The dried PVA film was stretched monoaxially in a machine direction at a stretching ratio of 1.2 times. The resultant film was heat-treated for 2 seconds by a heat treatment roll having a surface temperature of 160° C., and then, the film was rolled up, thereby obtaining a PVA film in a continuous length having a thickness of 60 μm.

The thicknesswise-directional average value of birefringence in a machine direction, swelling degree, penetration resistance and nutrient permeability of the obtained PVA film were measured or evaluated in accordance with the methods described above. Further, the PVA film was subjected to the root penetration test described above. The results are shown in Table 1 below.

### Comparative Example 12

With respect to a commercially available PVA film (thickness: 40 μm, manufactured by Aicello Chemical Co., Ltd.), the thicknesswise-directional average value of birefringence in a machine direction, swelling degree, penetration resistance and nutrient permeability of the PVA film were measured or evaluated in accordance with the methods described above. Further, the PVA film was subjected to the root penetration test described above. The results are shown in Table 1 below.

TABLE 1

| | | | | | | Results of evaluation | | | | |
|---|---|---|---|---|---|---|---|---|---|---|
| | Production conditions | | | | | | | Nutrient | | |
| | Moisture | | Tempera- | | | Penetration | | permeability | | |
| | content at | | ture | PVA film | | resistance | | (concentration | | Root |
| | stretching | Stretching | for heat | Δn | Swelling | (60 μm-value) | | difference) | | pene- |
| | [% by | ratio | treatment | (MD_{Ave}) | degree | | Evalua- | | Evalua- | tration |
| | mass] | [times] | [° C.] | ×10⁻³ | [%] | [N] | tion | [%] | tion | test |
| Example 1 | 15 | 1.4 | 160 | 6.1 | 160 | 16.4 | ∘ | 1.8 | ∘ | ∘ |
| Example 2 | 15 | 1.6 | 160 | 10.7 | 160 | 15.8 | ∘ | 1.9 | ∘ | ∘ |
| Example 3 | 15 | 1.4 | 140 | 6.3 | 170 | 15.8 | ∘ | 1.4 | ∘ | ∘ |
| Example 4 | 10 | 1.4 | 160 | 6.6 | 160 | 16.8 | ∘ | 1.9 | ∘ | ∘ |
| Comparative | — | 1.0 | 160 | 1.5 | 160 | 13.8 | x | 1.7 | ∘ | x |
| Example 1 | | | | | | | | | | |
| Comparative | — | 1.0 | 140 | 1.4 | 170 | 12.2 | x | 1.4 | ∘ | x |
| Example 2 | | | | | | | | | | |
| Comparative | — | 1.0 | 180 | 1.4 | 140 | 15.2 | ∘ | 2.5 | x | ∘ |
| Example 3 | | | | | | | | | | |
| Comparative | 15 | 1.2 | 160 | 3.4 | 160 | 14.5 | x | 1.7 | ∘ | x |
| Example 4 | | | | | | | | | | |
| Comparative | 15 | 1.8 | 160 | 13.6 | 160 | 17.2 | ∘ | 2.1 | x | ∘ |
| Example 5 | | | | | | | | | | |
| Comparative | 15 | 1.4 | 180 | 6.0 | 140 | 17.6 | ∘ | 2.6 | x | ∘ |
| Example 6 | | | | | | | | | | |
| Comparative | 15 | 1.4 | 120 | 5.9 | 190 | 8.9 | x | 1.2 | ∘ | x |
| Example 7 | | | | | | | | | | |
| Comparative | 22 | 1.4 | 160 | 2.5 | 160 | 14.0 | x | 1.7 | ∘ | x |
| Example 8 | | | | | | | | | | |
| Comparative | 3 | 1.4 | 160 | 6.2 | 190 | 8.6 | x | 1.3 | ∘ | x |
| Example 9 | | | | | | | | | | |
| Comparative | 3 | 1.6 | 160 | 10.6 | 200 | 4.4 | x | 1.2 | ∘ | x |
| Example 10 | | | | | | | | | | |
| Comparative | 1 | 1.2 | 160 | 2.5 | 240 | 6.4 | x | 0.9 | ∘ | x |
| Example 11 | | | | | | | | | | |
| Comparative | — | — | — | 2.6 | 165 | 8.2 | x | 1.9 | ∘ | x |
| Example 12 | | | | | | | | | | |

(In Table 1, Δn (MD_{Ave}) is a thicknesswise-directional average value of birefringence in a machine direction of the film.)

In Examples 1 to 4, the results of the evaluation of penetration resistance, nutrient permeability and root penetration test were all excellent (O). These results show that PVA films capable of suppressing root penetration while exhibiting excellent nutrient permeability were obtained in the Examples. On the other hand, in Comparative Examples 1 to 12, the PVA film simultaneously exhibiting excellent results with respect to all of the penetration resistance, nutrient permeability and root penetration test was not obtained.

### INDUSTRIAL APPLICABILITY

The PVA film for plant cultivation of the present invention is capable of suppressing root penetration while exhibiting excellent nutrient permeability. Accordingly the PVA film of the present invention can be used advantageously as a film for plant cultivation in cultivating not only flowering plants, but also relatively large fruit vegetables or leaf vegetables.

1. A polyvinyl alcohol film for plant cultivation, wherein a thicknesswise-directional average value of birefringence in a machine direction of the film is from 4.0×10⁻³ to 12.0×10⁻³ and a swelling degree of the film is from 150 to 180%.

2. The polyvinyl alcohol film for plant cultivation according to claim 1, wherein a penetration resistance of the film is 15.0 N or more in terms of a maximum load measured by a method comprising immersing the film in water at 20° C. for 1 minute and then piercing the film with a thick iron wire nail (CN65) defined in JIS A5508:2009, provided that the maximum load is a converted value exhibiting a maximum load when the thickness of the film is 60 μm.

3. A method for producing a polyvinyl alcohol film for plant cultivation, which comprises a step in which a polyvinyl alcohol film having a moisture content of from 5 to 20% by mass is stretched in the ratio of from 1.3 to 1.7 times and a step in which the stretched film is heat-treated at a temperature in the range of from 130 to 170° C.

4. The method according to claim 3, which further comprises, after the said step of stretching and before the said step of heat treatment, a step in which the film is dried so that the moisture content of the film becomes from 1 to 15% by mass.

5. A method for plant cultivation, which comprises cultivating the plant in the manner in which the plant and the polyvinyl alcohol film for plant cultivation according to claim 1 or 2 are directly contacted.
